(19) United States
(12) Patent Application Publication
(10) Pub. No.: US 2026/0253239 A1
(43) Pub. Date: Aug. 27, 2026

(54) SUBSTRATE INSPECTION METHOD AND SUBSTRATE INSPECTION SYSTEM

(71) Applicant: OPTZ Co., LTD., Suwon-si (KR)

(72) Inventors: Se Hyuk Park, Suwon-si (KR); Sung Bae Park, Suwon-si (KR); Deok ho Kim, Suwon-si (KR)

(73) Assignee: OPTZ Co., LTD., Suwon-si (KR)

(21) Appl. No.: 19/292,552

(22) Filed: Aug. 6, 2025

(30) Foreign Application Priority Data
Feb. 27, 2025 (KR) 10-2025-0025559

(51) Int. Cl. G06T 7/55; G06T 7/00

(52) U.S. Cl. CPC G06T 7/55; G06T 7/0004; G06T 2207/20212

(57) ABSTRACT

A substrate inspection method and a substrate inspection system according to an embodiment of the present disclosure include: receiving a first input image captured from above a glass substrate having a plurality of holes formed for electrode formation and a second input image captured from below the substrate; generating a first depth map including depth information of the first image and a second depth map including depth information of the second image based on the first input image and the second input image; generating a combined depth map by combining a portion of the first depth map and a portion of the second depth map; and calculating a depth line including shape information of the holes through the combined depth map and analyzing three-dimensional shapes and defects of the holes based on the depth line.

### CROSS-REFERENCE TO RELATED APPLICATION

This application claims priority under 35 U.S.C § 119 to Korean Patent Application No. 10-2025-0025559 filed on Feb. 27, 2025, in the Korean Intellectual Property Office, the entire contents of which are hereby incorporated by reference.

### TECHNICAL FIELD

The present disclosure relates to a substrate inspection method and a substrate inspection system.

### BACKGROUND

A glass substrate formed of glass material may be utilized in various advanced industries such as semiconductors, displays, and solar panels. The glass substrate has high insulation, heat resistance, and chemical stability, and precise processing of holes for forming electrodes is essential. In particular, advancements in hole processing technology serve as an important factor in enhancing the reliability of electronic components that are miniaturized and highly integrated.

The manufacturing process of a glass substrate may proceed in the order of raw material mixing, melting, forming, cooling, cutting and polishing, hole processing, cleaning, and inspection. First, high-purity silica (SiO₂) is mixed with other additives and melted at a high temperature, and then a substrate of a desired thickness is formed by using a float process, fusion process, or down-draw process. Subsequently, an annealing process for gradual cooling is performed to remove internal stress, and then the substrate is cut and its surface is polished. Hole processing for forming electrodes is carried out by methods such as laser drilling, ultrasonic machining (UAG), and chemical etching, and final quality is ensured through cleaning and defect inspection.

Since defects such as microcracks in the hole, processing deformation, and blockage caused by foreign substances may degrade the electrical characteristics and mechanical strength of the substrate, very precise processing is required. In particular, since glass has a transparent property, it may be difficult to detect minute defects inside the hole using a conventional optical inspection method. In addition, holes processed by laser drilling and the like may undergo minute deformation due to thermal effects, and the process of accurately inspecting and analyzing such defects involves a high level of technical difficulty.

### SUMMARY

An object of the present disclosure is to provide a substrate inspection method and a substrate inspection system that generate an image-based depth map for a hole formed in a glass substrate for electrode formation, and analyze a three-dimensional shape and a defect of the hole based on a depth line calculated from the depth map.

The problems to be solved by the present disclosure are not limited to those mentioned above, and other problems not mentioned will be clearly understood by those of ordinary skill in the art from the following description.

According to an embodiment of the present disclosure, a substrate inspection method includes: receiving a first input image captured from above a glass substrate having a plurality of holes formed for electrode formation and a second input image captured from below the substrate; generating a first depth map including depth information of the first image and a second depth map including depth information of the second image based on the first input image and the second input image; generating a combined depth map by combining a portion of the first depth map and a portion of the second depth map; and calculating a depth line including shape information of the holes through the combined depth map and analyzing a three-dimensional shape and a defect of the holes based on the depth line.

Specifically, in the step of generating the combined depth map, a first reference line for the first depth map and a second reference line for the second depth map is set, and the combined depth map is generated by combining a one-side portion based on the first reference line in the first depth map and an opposite-side portion based on the second reference line in the second depth map, wherein the first reference line and the second reference line may be set to pass through the brightest portion of the first depth map and the second depth map.

Specifically, in the step of analyzing the three-dimensional shape and the defect of the holes, a weighting adjustment and approximation are performed on the depth line, and a three-dimensional shape of the holes is generated through the depth line, and then the defect of the holes may be analyzed based on the generated three-dimensional shape.

Specifically, the first depth map may represent the depth information of the holes in a radial manner when viewed from above, the second depth map may represent the depth information of the holes in a radial manner when viewed from below, and the depth line may represent shape information of the holes in a linear manner when viewed from the side.

Specifically, the hole may be formed in an hourglass shape penetrating the substrate in a defect-free state.

A substrate inspection system according to an embodiment of the present disclosure includes: an image input part configured to receive a first input image captured from above a glass substrate having a plurality of holes formed for electrode formation and a second input image captured from below the substrate; a depth map generation part configured to generate a first depth map including depth information of the first image and a second depth map including depth information of the second image based on the first input image and the second input image; a combined depth map generation part configured to generate a combined depth map by combining a portion of the first depth map and a portion of the second depth map; and a three-dimensional shape and defect analysis part configured to calculate a depth line including shape information of the holes through the combined depth map and to analyze a three-dimensional shape and a defect of the holes based on the depth line.

Specifically, the combined depth map generation part sets a first reference line for the first depth map and a second reference line for the second depth map, and generates the combined depth map by combining a one-side portion based on the first reference line in the first depth map and an opposite-side portion based on the second reference line in the second depth map, wherein the first reference line and the second reference line may be set to pass through the brightest portion of the first depth map and the second depth map.

Specifically, the three-dimensional shape and defect analysis part may perform weighting adjustment and approximation on the depth line, generate a three-dimensional shape of the holes through the depth line, and analyze the defect of the holes based on the generated three-dimensional shape.

Specifically, the first depth map may represent the depth information of the holes in a radial manner when viewed from above, the second depth map may represent the depth information of the holes in a radial manner when viewed from below, and the depth line may represent shape information of the holes in a linear manner when viewed from the side.

Specifically, the hole may be formed in an hourglass shape penetrating the substrate in a defect-free state.

The substrate inspection method and the substrate inspection system according to an embodiment of the present disclosure may generate an image-based depth map for a hole formed in a glass substrate for electrode formation, and analyze a three-dimensional shape and a defect of the hole based on a depth line calculated from the depth map.

The effects of the present disclosure are not limited to those mentioned above, and other effects not mentioned will be clearly understood by those of ordinary skill in the art from the description of the claims.

### BRIEF DESCRIPTION OF THE DRAWINGS

FIG. 1 is a diagram illustrating a substrate inspection system according to an embodiment of the present disclosure.

FIG. 2 is a diagram illustrating a substrate and a plurality of holes provided in the substrate, which is the target of the substrate inspection system according to an embodiment of the present disclosure.

FIG. 3 is a diagram illustrating a depth map and a heat map in the substrate inspection system according to an embodiment of the present disclosure.

FIG. 4 is a diagram illustrating generation of a first depth map and a second depth map and illustrating depth lines based on reference lines with respect to the first depth map and the second depth map in the substrate inspection system according to an embodiment of the present disclosure.

FIG. 5 is a diagram illustrating a combined depth map generated by combining a portion of the first depth map and a portion of the second depth map, and a depth line calculated from the combined depth map, in the substrate inspection system according to an embodiment of the present disclosure.

FIG. 6A to FIG. 6D are diagrams illustrating three-dimensional shapes of a hole in a defect-free state and holes with defects in the substrate inspection system according to an embodiment of the present disclosure.

FIG. 7A to FIG. 7D are diagrams illustrating depth lines for a hole in a defect-free state and holes with defects in the substrate inspection system according to an embodiment of the present disclosure.

FIG. 8 is a flowchart illustrating a substrate inspection method according to an embodiment of the present disclosure.

FIG. 9 is a diagram illustrating a process of generating a combined depth map and calculating a depth line for a first case in the substrate inspection method according to an embodiment of the present disclosure.

FIG. 10 is a diagram illustrating a process of performing weighting adjustment and approximation of the depth line and generating a three-dimensional shape for the first case in the substrate inspection method according to an embodiment of the present disclosure.

FIG. 11 is a diagram illustrating a process of generating a combined depth map and calculating a depth line for a second case in the substrate inspection method according to an embodiment of the present disclosure.

FIG. 12 is a diagram illustrating a process of performing weighting adjustment and approximation of the depth line and generating a three-dimensional shape for the second case in the substrate inspection method according to an embodiment of the present disclosure.

FIG. 13 is a diagram illustrating a process of generating a combined depth map and calculating a depth line for a third case in the substrate inspection method according to an embodiment of the present disclosure.

FIG. 14 is a diagram illustrating a process of performing weighting adjustment and approximation of the depth line and generating a three-dimensional shape for the third case in the substrate inspection method according to an embodiment of the present disclosure.

### DETAILED DESCRIPTION OF THE PREFERRED EMBODIMENTS

The objects, specific advantages, and novel features of the present disclosure will become more apparent from the following detailed description and preferred embodiments in conjunction with the accompanying drawings. In the present specification, in assigning reference numerals to components in the drawings, it should be noted that, for the same components, the same reference numerals are used as much as possible, even if they appear in different drawings. In addition, in describing the present disclosure, detailed descriptions of related known technologies will be omitted when it is determined that they would unnecessarily obscure the gist of the present disclosure.

Hereinafter, preferred embodiments of the present disclosure will be described in detail with reference to the accompanying drawings.

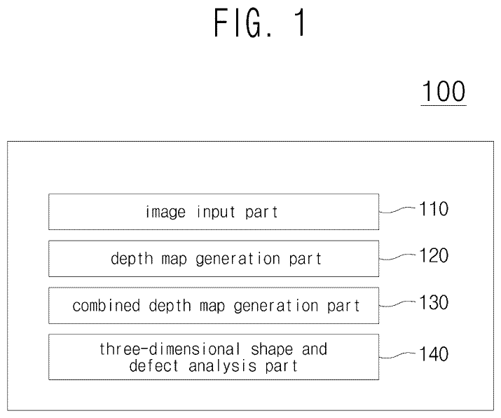

FIG. 1 is a diagram illustrating a substrate inspection system according to an embodiment of the present disclosure.

Referring to FIG. 1, a substrate inspection system 100 according to an embodiment of the present disclosure includes an image input part 110, a depth map generation part 120, a combined depth map generation part 130, and a three-dimensional shape and defect analysis part 140.

A substrate 1, which is a target of the substrate inspection system 100 according to an embodiment of the present disclosure, may be a glass substrate 1 including a plurality of holes 10 formed for electrode formation.

The glass substrate 1, which is the target of the substrate inspection system 100 of the present disclosure, includes through-glass vias (TGVs). The through-glass vias are formed by semiconductor packaging technology, and the through-glass vias are formed by processing fine holes 10 in the glass substrate 1 and then filling the holes 10 with a conductive material to form electrical connections.

The through-glass vias of the glass substrate 1 are similar to conventional through-silicon vias (TSVs), but differ in that the substrate 1 is made of glass instead of silicon. Hereinafter, the through-glass vias are described as the through-glass vias of the glass substrate 1.

The through-glass vias have advantages such as ease of fine circuit formation, low coefficient of thermal expansion, high thermal conductivity, excellent flexibility, and low processing cost. Accordingly, the through-glass vias are widely used in fields such as high-performance computing, artificial intelligence, and advanced semiconductor packaging.

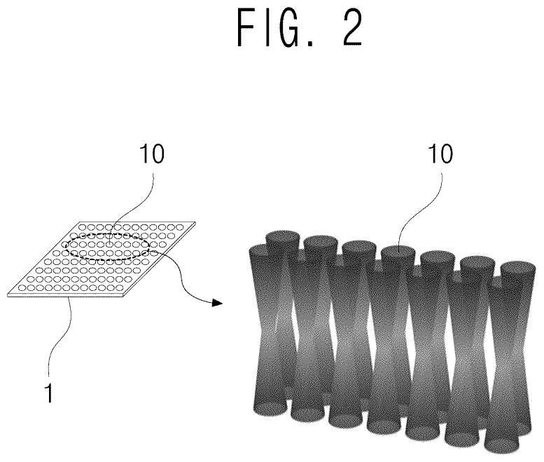

However, since the shape and internal structure of the holes 10 in the glass substrate 1 directly affect not only the mechanical strength but also the electrical characteristics, analysis of defects in the holes 10 is essential. Defects such as cracks inside the holes 10, microcracks, and poor metal filling may cause signal transmission degradation and durability issues. A detailed description of the specific shape of the holes 10 will be provided below with reference to FIG. 2.

The image input part 110 receives a first input image captured from above the substrate 1 and a second input image captured from below the substrate 1. The first input image and the second input image are images captured from above and below with respect to the same hole 10. A plurality of the first input images and the second input images may be provided in order to include images of a plurality of holes 10. The first input image and the second input image may each be composed of an image including the deepest point (penetrated point) of the hole 10.

The depth map generation part 120 generates a first depth map including depth information of the first image and a second depth map including depth information of the second image based on the first input image and the second input image.

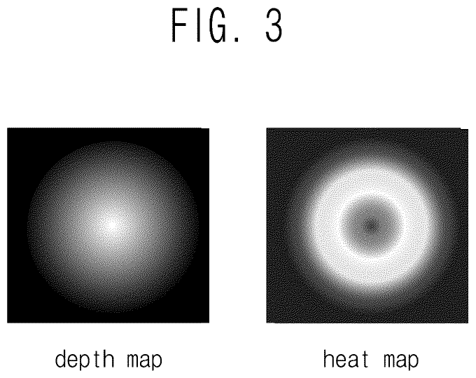

The substrate inspection system 100 according to an embodiment of the present disclosure may use a three-dimensional modeling technique utilizing a depth map in order to precisely analyze a three-dimensional shape and a defect of a hole 10 formed in the glass substrate 1. Through this, the present disclosure may induce improvement in the quality of the through-glass vias by visually confirming the defect of the hole 10 and ensure the reliability of semiconductor packaging. A detailed description of the depth map will be provided below with reference to FIG. 3.

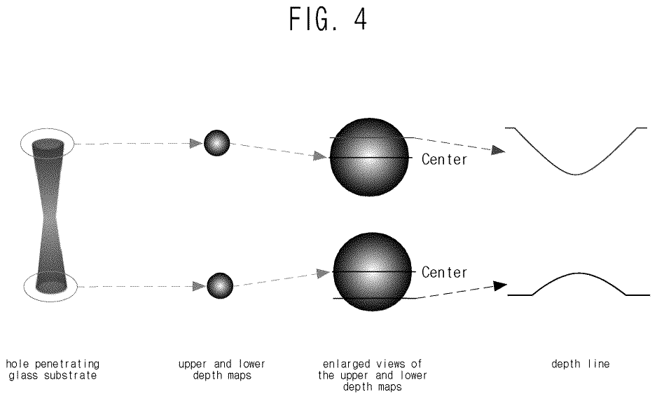

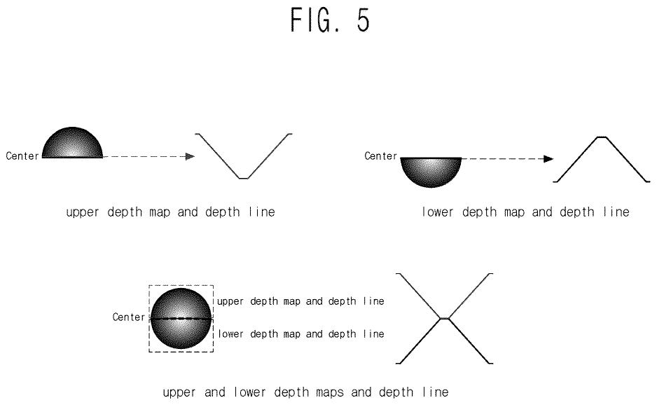

The combined depth map generation part 130 generates a combined depth map by combining a portion of the first depth map and a portion of the second depth map. A detailed description of the combined depth map generation will be provided below with reference to FIGS. 4 and 5.

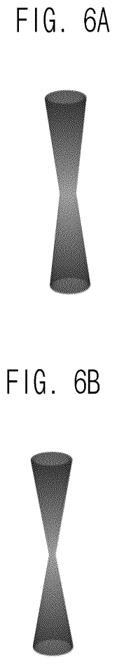

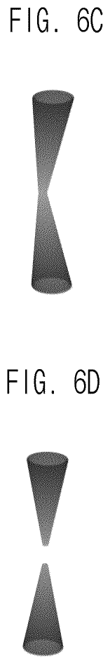

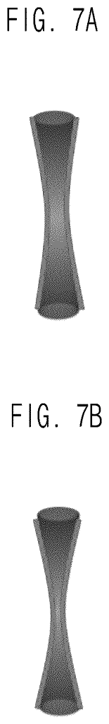

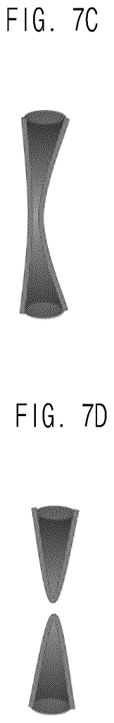

The three-dimensional shape and defect analysis part 140 calculates a depth line including shape information of the hole 10 by using the combined depth map and analyzes a three-dimensional shape and a defect of the hole 10 based on the depth line. A detailed description of the analysis of the depth line and the three-dimensional shape and defect of the hole 10 will be provided below with reference to FIG. 6A to FIG. 6D and FIG. 7A to FIG. 7D.

FIG. 2 is a diagram illustrating a substrate and a plurality of holes provided in the substrate, which is the target of the substrate inspection system according to an embodiment of the present disclosure.

Referring to FIG. 2, the shape of a hole 10 for forming a through-glass via in a glass substrate 1, which is a target of the substrate inspection system 100 according to an embodiment of the present disclosure, is illustrated. The shape of the hole 10 for forming the through-glass via may be variously provided depending on the application field of the glass substrate 1. For example, the hole 10 may be formed in various shapes such as a straight via, a tapered via, a reverse tapered via, or an hourglass via.

A straight via has a simple structure and is easy to fabricate, but as the depth of the hole 10 increases, the aspect ratio increases, which leads to increased processing difficulty.

A tapered via has a structure in which the entrance of the hole 10 is wide and narrows downward, making it easy to fill with conductive material and improving the reliability of electrical connection.

A reverse tapered via has a shape in which the entrance of the hole 10 is narrow and the bottom is wider; it is used for special purposes but may be difficult to fabricate.

An hourglass via has a shape in which the upper and lower portions are wide and the middle portion is narrow, which facilitates the filling of conductive material and improves electrical signal transmission characteristics. The hourglass structure may satisfy a high aspect ratio required for high-density semiconductor packaging, and enhance mechanical strength and improve electrical performance.

However, in a defect-free state, the glass substrate 1 targeted by the present disclosure is formed in an hourglass shape in which the hole 10, which is for forming a through-glass vias, penetrates the substrate 1.

The substrate inspection system 100 according to an embodiment of the present disclosure may generate a three-dimensional shape of the hole 10, which is formed in an hourglass shape, by using a depth map and a depth line, and analyze a defect of the hole 10.

FIG. 3 is a diagram illustrating a depth map and a heat map in the substrate inspection system according to an embodiment of the present disclosure.

Referring to FIG. 3, a depth map is an image indicating how far each pixel is from a reference point (e.g., a camera). In general, a depth map may be represented in gray levels.

In a depth map, a dark color indicates that the distance from the reference point is short, and a bright color indicates that the distance from the reference point is long.

On the other hand, a heat map is used to intuitively represent defect distribution or changes in electrical characteristics. For example, defects such as microcracks or uneven plating occurring during a specific manufacturing process can be easily identified through a heat map. In addition, a heat map may also be used to analyze thermal distribution during a manufacturing process or to detect processing imbalance in the course of manufacturing.

That is, a depth map may be used for quantitatively analyzing the depth and shape of a specific portion, whereas a heat map may be used for intuitively visualizing defects and the like. Although the present disclosure mainly uses a depth map to analyze a three-dimensional shape and a defect of the hole 10, it is noted that a heat map may be used instead of the depth map.

Examples of methods for generating a depth map include stereo vision, structured light, a time-of-flight (ToF) sensor, and monocular depth estimation. The present disclosure may generate a depth map by using a monocular depth estimation technique, but is not limited thereto.

FIG. 4 is a diagram illustrating generation of a first depth map and a second depth map and illustrating depth lines based on reference lines with respect to the first depth map and the second depth map in the substrate inspection system according to an embodiment of the present disclosure.

Referring to FIG. 4, a first depth map (upper depth map) includes depth information of the hole 10 when viewed from above, and a second depth map (lower depth map) includes depth information of the hole 10 when viewed from below.

In the case of a defect-free hourglass-shaped hole 10, the first depth map and the second depth map may appear in a radial form in which the brightness becomes darker from the center (white) toward the outside (black), and the brightest portion in the depth map may be located on a center line passing through the center of the depth map.

When a depth line is calculated based on a line traversing the first depth map and the second depth map, the depth line may intuitively show the depth information of the hole 10 along the corresponding line.

FIG. 5 is a diagram illustrating a combined depth map generated by combining a portion of the first depth map and a portion of the second depth map, and a depth line calculated from the combined depth map, in the substrate inspection system according to an embodiment of the present disclosure.

Referring to FIG. 5, in the substrate inspection system 100 according to an embodiment of the present disclosure, the combined depth map generation part 130 may set a first reference line for the first depth map (upper depth map) and a second reference line for the second depth map (lower depth map).

The first reference line and the second reference line may be set to be lines that pass through the brightest portions of the first depth map and the second depth map.

The combined depth map generation part 130 generates a combined depth map by combining a one-side portion divided based on the first reference line in the first depth map and an opposite-side portion divided based on the second reference line in the second depth map.

The depth line calculated based on the combined depth map has an hourglass shape corresponding to the shape of the hole 10. Such a depth line may be adjusted to the same scale as the actual shape of the hole 10 through subsequent weighting adjustment and approximation, and the present disclosure may confirm the three-dimensional shape of the hole 10 through this process.

In the case of FIG. 5, a depth map for a defect-free hourglass-shaped hole 10 is illustratively shown. At this time, the first reference line and the second reference line are set to pass through the exact center (the brightest portion) of the first depth map and the second depth map. In addition, the combined depth map generated by combining a portion of the first depth map and a portion of the second depth map may be identical to either the first depth map or the second depth map.

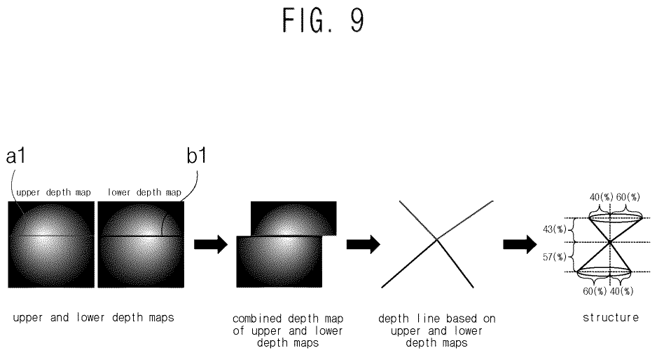

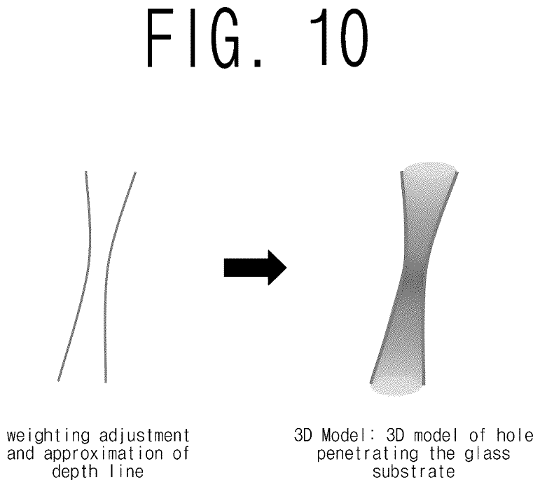

Also, the depth line calculated by the combined depth map is represented as a defect-free symmetric hourglass shape. Cases in which the hole 10 has defects will be described below with reference to FIGS. 9 to 14.

FIG. 6A to FIG. 6D are diagrams illustrating three-dimensional shapes of a hole in a defect-free state and holes with defects in the substrate inspection system according to an embodiment of the present disclosure. FIG. 7A to FIG. 7D are diagrams illustrating depth lines for a hole in a defect-free state and holes with defects in the substrate inspection system according to an embodiment of the present disclosure.

Referring to FIG. 6A to FIG. 6D and FIG. 7A to FIG. 7D, the three-dimensional shape and defect analysis part 140 performs weighting adjustment and approximation on the depth line. The three-dimensional shape and defect analysis part 140 may generate a three-dimensional shape of the hole 10 through the depth line and analyze a defect of the hole 10 based on the generated three-dimensional shape.

In FIG. 6A to FIG. 6D and FIG. 7A to FIG. 7D, FIG. 6A and FIG. 7A represent a case in which the hourglass-shaped hole 10 is free of defects, and FIG. 6B, FIG. 6C, FIG. 6D, FIG. 7B, FIG. 7C and FIG. 7D represent cases in which the hourglass-shaped hole 10 has defects.

In the case of FIG. 6B and FIG. 7B, the defect of the hole 10 is that the narrowest part is formed too narrowly; in the case of FIG. 6C and FIG. 7C, the defect of the hole 10 is that the narrowest part is not located at the center. In the case of FIG. 6D and FIG. 7D, the defect is that the hole 10 is not fully penetrated.

The depth line linearly represents shape information of the hole 10 when the glass substrate 1 is viewed from the side. FIG. 7A, FIG. 7B, FIG. 7C and FIG. 7D illustrates that the depth lines are formed along the boundaries of the holes 10 in each of the cases shown in FIG. 6A, FIG. 6B, FIG. 6C and FIG. 6D.

That is, the substrate inspection system 100 according to an embodiment of the present disclosure may receive a first input image and a second input image for the hole 10 formed in the glass substrate 1 to be inspected, generate depth maps based on the first input image and the second input image, and inspect a defect of the hole 10 formed in the glass substrate 1 by comparing the depth line calculated from the depth maps with reference data, which is the depth line shown in FIG. 7A.

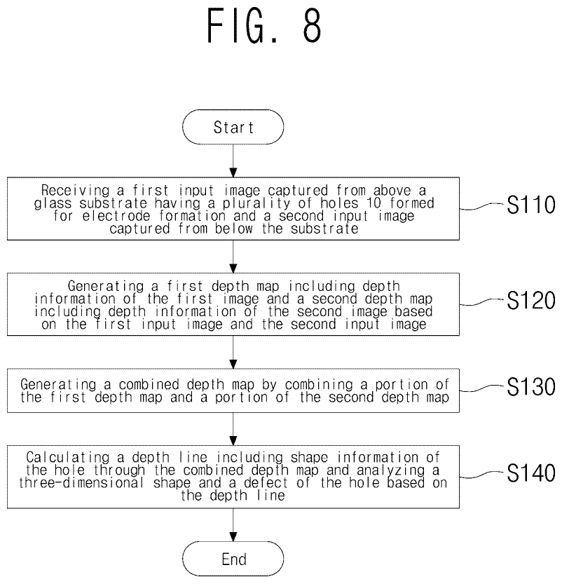

FIG. 8 is a flowchart illustrating a substrate inspection method according to an embodiment of the present disclosure.

Referring to FIG. 8, a substrate inspection method according to an embodiment of the present disclosure includes: a step (S110) of receiving a first input image captured from above a glass substrate 1 having a hole 10 for electrode formation and a second input image captured from below the substrate 1; a step (S120) of generating a first depth map including depth information of the first image and a second depth map including depth information of the second image based on the first input image and the second input image; a step (S130) of generating a combined depth map by combining a portion of the first depth map and a portion of the second depth map; and a step (S140) of calculating a depth line including shape information of the hole through the combined depth map and analyzing a three-dimensional shape and a defect of the hole based on the depth line.

In the glass substrate 1 targeted by the present disclosure, the hole 10 for forming a through-glass via is formed in an hourglass shape penetrating the substrate 1 in a defect-free state.

The first depth map represents the depth information of the hole 10 in a radial form when the hole 10 is viewed from above, and the second depth map represents the depth information of the hole 10 in a radial form when the hole 10 is viewed from below. The depth line linearly represents the shape information of the hole 10 when the hole 10 is viewed from the side.

In the substrate inspection method according to an embodiment of the present disclosure, the step (S130) of generating the combined depth map includes setting a first reference line for the first depth map and a second reference line for the second depth map, and generating the combined depth map by combining a one-side portion divided based on the first reference line in the first depth map and an opposite-side portion divided based on the second reference line in the second depth map. At this time, the first reference line and the second reference line are set to pass through the brightest portions of the first depth map and the second depth map.

In the substrate inspection method according to an embodiment of the present disclosure, the step (S140) of analyzing the three-dimensional shape and the defect of the hole 10 includes calculating a depth line through the combined depth map and performing weighting adjustment and approximation on the depth line. Through this, the present disclosure may generate a three-dimensional shape of the hole 10 and analyze a defect of the hole 10 based on the generated three-dimensional shape.

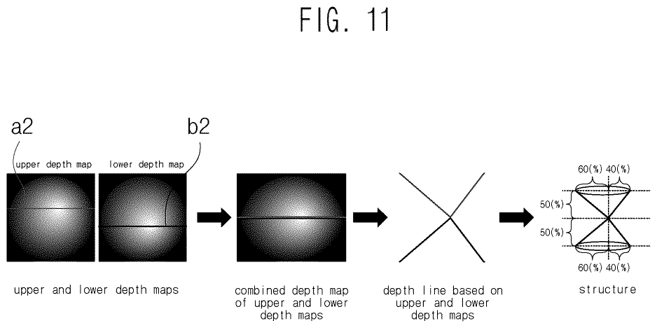

FIG. 9 is a diagram illustrating a process of generating a combined depth map and calculating a depth line for a first case in the substrate inspection method according to an embodiment of the present disclosure. FIG. 10 is a diagram illustrating a process of performing weighting adjustment and approximation of the depth line and generating a three-dimensional shape for the first case in the substrate inspection method according to an embodiment of the present disclosure.

Referring to FIGS. 9 and 10, a first case is a case in which the brightest portion of the first depth map (upper depth map) is located at the upper left, and the brightest portion of the second depth map (lower depth map) is located at the upper right. That is, the first case has a defect in which the narrowest part of the hole 10 is located at a position offset from the center.

In the first case, the present disclosure sets a first reference line a1 and a second reference line b1 based on the brightest portions in the first depth map and the second depth map, and generates a combined depth map by combining an upper portion of the first depth map divided by the first reference line and a lower portion of the second depth map divided by the second reference line.

The present disclosure may calculate a depth line for the first case through the combined depth map and analyze the structure of the hole 10 through the calculated depth line. At this time, the present disclosure may perform weighting adjustment and approximation on the depth line, thereby generating a three-dimensional shape of the hole 10 that penetrates the glass substrate 1, and analyze a defect of the hole 10 based on the generated three-dimensional shape.

Through this process, as shown in FIG. 10, the present disclosure may confirm that the hole 10 formed in the glass substrate 1 in the first case has a defect in which the axis of the hole 10 is overall inclined.

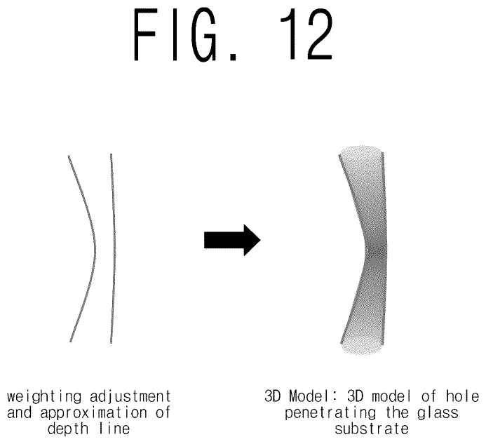

FIG. 11 is a diagram illustrating a process of generating a combined depth map and calculating a depth line for a second case in the substrate inspection method according to an embodiment of the present disclosure. FIG. 12 is a diagram illustrating a process of performing weighting adjustment and approximation of the depth line and generating a three-dimensional shape for the second case in the substrate inspection method according to an embodiment of the present disclosure.

Referring to FIGS. 11 and 12, a second case is a case in which the brightest portion of the first depth map (upper depth map) is located at the upper right, and the brightest portion of the second depth map (lower depth map) is located at the lower right. That is, the second case has a defect in which the narrowest part of the hole 10 is formed at a position offset from the center. However, as will be described below, the defect of the second case may differ from that of the first case.

In the second case, the present disclosure sets a first reference line a2 and a second reference line b2 based on the brightest portions in the first depth map and the second depth map, and generates a combined depth map by combining an upper portion of the first depth map divided by the first reference line and a lower portion of the second depth map divided by the second reference line.

The present disclosure may calculate a depth line for the second case through the combined depth map and analyze the structure of the hole 10 through the calculated depth line. At this time, the present disclosure may perform weighting adjustment and approximation on the depth line, thereby generating a three-dimensional shape of the hole 10 that penetrates the glass substrate 1, and analyze a defect of the hole 10 based on the generated three-dimensional shape.

Through this process, as shown in FIG. 12, the present disclosure may confirm that the hole 10 formed in the glass substrate 1 in the second case has a defect in which the axis of the hole 10 is shifted to the right.

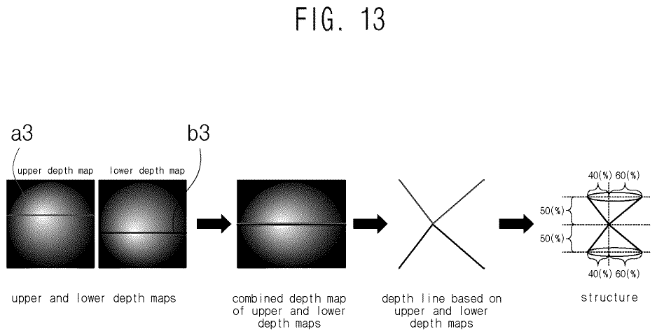

FIG. 13 is a diagram illustrating a process of generating a combined depth map and calculating a depth line for a third case in the substrate inspection method according to an embodiment of the present disclosure.

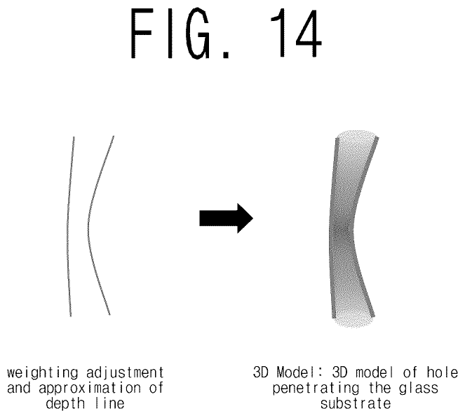

FIG. 14 is a diagram illustrating a process of performing weighting adjustment and approximation of the depth line and generating a three-dimensional shape for the third case in the substrate inspection method according to an embodiment of the present disclosure.

Referring to FIGS. 13 and 14, a third case is a case in which the brightest portion of the first depth map (upper depth map) is located at the upper left, and the brightest portion of the second depth map (lower depth map) is located at the lower left. That is, the third case has a defect in which the narrowest part of the hole 10 is formed at a position offset from the center, and the position of the narrowest part of the hole 10 differs from that of the second case.

In the third case, the present disclosure sets a first reference line a3 and a second reference line b3 based on the brightest portions in the first depth map and the second depth map, and generates a combined depth map by combining an upper portion of the first depth map divided by the first reference line and a lower portion of the second depth map divided by the second reference line.

The present disclosure may calculate a depth line for the third case through the combined depth map and analyze the structure of the hole 10 through the calculated depth line. At this time, the present disclosure may perform weighting adjustment and approximation on the depth line, thereby generating a three-dimensional shape of the hole 10 that penetrates the glass substrate 1, and analyze a defect of the hole 10 based on the generated three-dimensional shape.

Through this process, as shown in FIG. 14, the present disclosure may confirm that the hole 10 formed in the glass substrate 1 in the third case has a defect in which the axis of the hole 10 is shifted to the left.

As described above, the substrate inspection method according to an embodiment of the present disclosure may generate depth maps based on images captured from both sides of the glass substrate 1 in order to analyze the hole 10 for electrode formation in the glass substrate 1, calculate a depth line representing the shape of the hole 10 by combining the depth maps, and clearly analyze a defect of the hole 10 based on the depth line.

While the present disclosure has been described above with reference to embodiments thereof, such embodiments are merely illustrative and are not intended to limit the present disclosure, and it will be understood by those of ordinary skill in the art to which the present disclosure pertains that various combinations, modifications, and applications not exemplified in the embodiments are possible without departing from the essential technical spirit of the embodiments. Accordingly, technical content related to modifications and applications that can be easily derived from the embodiments of the present disclosure shall also be interpreted as being included in the present disclosure.

### DESCRIPTION OF REFERENCE NUMERALS

| | |
|---|---|
| 100: substrate inspection system | |
| 110: image input part | 120: depth map generation part |
| 130: combined depth map generation part | 140: three-dimensional shape and |
| defect analysis part | |

What is claimed is:

1. A substrate inspection method comprising:
receiving a first input image captured from above a glass substrate having a plurality of holes formed for electrode formation and a second input image captured from below the substrate;
generating a first depth map including depth information of the first image and a second depth map including depth information of the second image based on the first input image and the second input image;
generating a combined depth map by combining a portion of the first depth map and a portion of the second depth map; and
calculating a depth line including shape information of the holes through the combined depth map and analyzing three-dimensional shapes and defects of the holes based on the depth line.

2. The substrate inspection method according to claim 1,
wherein, in the generation of the combined depth map,
a first reference line for the first depth map and a second reference line for the second depth map are set, and
the combined depth map is generated by combining a one-side portion divided based on the first reference line in the first depth map and an opposite-side portion divided based on the second reference line in the second depth map,
wherein the first reference line and the second reference line are set to pass through the brightest portions of the first depth map and the second depth map.

3. The substrate inspection method according to claim 1,
wherein, in the analysis of the three-dimensional shapes and defects of the holes,
weighting adjustment and approximation are performed on the depth line, the three-dimensional shapes of the holes are generated through the depth line, and the defects of the holes are analyzed based on the generated three-dimensional shapes.

4. The substrate inspection method according to claim 1,
wherein the first depth map represents depth information of the hole in a radial form when the hole is viewed from above,
the second depth map represents depth information of the hole in a radial form when the hole is viewed from below, and
the depth line represents shape information of the hole in a linear form when the hole is viewed from the side.

5. The substrate inspection method according to claim 1,
wherein the hole is formed in an hourglass shape penetrating the substrate in a defect-free state.

6. A substrate inspection system comprising:
an image input part configured to receive a first input image captured from above a glass substrate having a plurality of holes formed for electrode formation and a second input image captured from below the substrate;
a depth map generation part configured to generate a first depth map including depth information of the first image and a second depth map including depth information of the second image based on the first input image and the second input image;
a combined depth map generation part configured to generate a combined depth map by combining a portion of the first depth map and a portion of the second depth map; and
a three-dimensional shape and defect analysis part configured to calculate a depth line including shape information of the holes through the combined depth map and analyze three-dimensional shapes and defects of the holes based on the depth line.

7. The substrate inspection system according to claim 6,
wherein the combined depth map generation part is configured:
to set a first reference line for the first depth map and a second reference line for the second depth map, and
to generate the combined depth map by combining a one-side portion divided based on the first reference line in the first depth map and an opposite-side portion divided based on the second reference line in the second depth map,
wherein the first reference line and the second reference line are set to pass through the brightest portions of the first depth map and the second depth map.

8. The substrate inspection system according to claim 6,
wherein the three-dimensional shape and defect analysis part is configured to perform weighting adjustment and approximation on the depth line, generate the three-dimensional shape of the hole through the depth line, and analyze defects of the hole based on the generated three-dimensional shape.

9. The substrate inspection system according to claim 6,
wherein the first depth map represents depth information of the hole in a radial form when the hole is viewed from above,
the second depth map represents depth information of the hole in a radial form when the hole is viewed from below, and
the depth line represents shape information of the hole in a linear form when the hole is viewed from the side.

10. The substrate inspection system according to claim 6,
wherein the hole is formed in an hourglass shape penetrating the substrate in a defect-free state.
